(19) United States
(12) Patent Application Publication
(10) Pub. No.: US 2015/0290593 A1
(43) Pub. Date: Oct. 15, 2015

(54) Tubular Membrane Support System

(71) Applicant: Advanced Metallurgical Solutins Pty. Ltd., Lonsdale (AU)

(72) Inventors: Gilbert Erskine, Lonsdale (AU); Craig Erskine, Onkaparinga Hills (AU)

(21) Appl. No.: 14/377,390

(22) PCT Filed: Feb. 7, 2013
(86) PCT No.: PCT/AU2013/000100

§ 371 Date: Aug. 7, 2014

(30) Foreign Application Priority Data
Feb. 8, 2012 (AU) 2012900460

(51) Int. Cl. B01D 71/02; B01D 69/04; B22F 7/04; B22F 3/12; B22F 3/26; B22F 5/00; B01D 63/06; B01D 67/00

(52) U.S. Cl. CPC B01D 71/022; B01D 63/061; B01D 69/04; B01D 67/0041; B22F 3/12; B22F 3/26; B22F 5/00; B22F 7/04; B22F 2007/045

(57) ABSTRACT

A metallic face plate comprising a plurality of metallic tubular membranes adapted for a tubular membrane module, wherein the metallic tubular membranes and the metallic face plate are not joined by a weld and wherein the internal diameter of each tubular membrane is selected from the group consisting of; between 2 mm and 21 mm; between 2 mm and 20 mm; between 2 mm and 19 mm; between 2 mm and 18 mm; between 2 mm and 17 mm; between 2 mm and 16 mm; between 2 mm and 15 mm; between 5 mm and 20 mm; and between 5 mm and 15 mm.

### FIELD OF THE INVENTION

The present invention relates to metallic tubular membranes and, in particular, metallic support systems for tubular membranes.

### BACKGROUND

Tubular membranes are used in numerous industries to filter and separate particulates from fluid and gas. The membranes can be constructed from various materials depending on their application, including plastic mesh, fine plastic tubes, porcelain or stainless steel mesh.

Many currently available tubular membranes, such as the conventional fine plastic tubes, are prone to blockage. The configuration of the fine plastic tubes means that any blockage can result in putrefaction of the impurities which in turn leads to a reduction in the permeate quality due to the impartation of undesirable flavour characteristics.

Recently, stainless steel mesh has been put forward as a replacement to conventional filters. The advantage with this material is that it is easy to clean and more robust than porcelain which can have a tendency to shatter under high pressure. However, present methods of producing stainless steel filters suffer from a number of drawbacks, including the fact that it is difficult to produce a pore size within the mesh to adequately filter small particles. Furthermore, it is difficult to produce a mesh with evenly spaced pores, which can limit the effective open area of the mesh.

Membranes, or indeed any other type of filtration media, are purely barriers to prevent the movement of particulates such as detritus and bacteria. In theory, a membrane with single channel pore would be an ideal filter. This is not, however, commercially viable.

What actually occurs in filters, such as porcelain and metal filters, is that the fluid is forced along a torturous path from the retentate side of the membrane to the permeate side. In the process particulate material and bacteria is filtered out of the liquid. This has several disadvantages, for instance since there is a higher transmembrane pressure drop, there is risk of permanent plugging from particulates being trapped within the membrane itself which makes it harder to clean.

In order to minimize these disadvantages and reduce the effects of permanent plugging, manufactures have attempted to perfect the use of a thin layer on the inside or outside of the filter wall. These filters include an outer support tube produced with varying grades of metallic powder. This outer tube is fired and a thin coat is applied to either the internal or external surface using a much finer powder and the filter is then re-fired. One of the problems is that the layers can tend to laminate or separate due to the two step firing process.

Metallic tubular membranes, and in particular multilayered metallic tubular membranes, have overcome many of these aforementioned problems wherein the membrane includes a plurality of apertures extending there through, and at least some of said apertures increase in cross-sectional area from a first surface of the membrane to a second surface of the membrane.

Metallic tubular membranes are used in a variety of industries for the separation of particulates in liquid or gas and have a number of advantages over plastic tubular membranes. Metallic tubular membranes are robust and, depending on the metal used, can withstand both temperatures up to 900° C., have a high pressure tolerance and can tolerate highly corrosive environments.

WO 2008/064390 and WO 2008/064391 describes various multilayered metallic tubular membranes which are produced by building the membrane from the inside out, with powders having particle sizes that gradually increase thereby forming an aperture matrix wherein the cross-sectional area of the apertures increase as the apertures extend from the inside surface of the tube to the outside surface. This reduces the risk of plugging, which in turn reduces power input to operate the filtering machine where the metallic filter membrane is housed. WO 2008/064390 describes methods of producing metallic tubular membranes wherein the metal powder is loose gravity filled into a mould which has a solid mandrel and an elastomer outer. Once filled, the mould is then placed into an isostatic press and compressed under pressure up to 60,000 psi. The resultant green compact, as it is referred to, is then sintered in a furnace having an inert atmosphere. This method produces a membrane with a substantially symmetric cross-sectional profile which suffers from similar permanent plugging issues as porcelain filters.

Metallic tubular membranes are often arranged into tubular modules, wherein a plurality of tubes, arranged in parallel, are contained within a sealed container or outer housing. The outer tube or housing often receives the permeate. The tubes are joined together via one or more tube face plates at one or more ends of the membrane module. This arrangement has the advantage of compacting the tubular membranes into a defined space resulting in significant capital and running cost savings. WO 2012/009762 describes methods to produce membrane modules wherein the membranes have diameters between 1 mm and 20 mm, which are welded onto face plates to form membrane modules.

Tube face plates can be constructed out of a number of materials including metal, plastic or porcelain depending on the application and construction of the tubular membranes. Metallic face plates are often used for metallic tubular membrane modules. In these arrangements, each individual metallic tubular membrane is welded onto the metallic face plate. One problem with this arrangement is that because welding is used to affix the tube to the face plate, this limits the diameter of tube that can be used. Tubes with internal diameters below 21 mm are difficult or impossible to weld onto face plates without risk of damage; the heat zone produced adjacent to the weld will cause damage to the membrane due to heat and oxidation and it can become prone to corrosion; the high welding temperatures used (up to 2200° C.) can damage the fine inner coat that is the active membrane, causing a change in the micron size and porosity of the membranes. Because of these problems, such membranes cannot be classified as being “absolute” in terms of their properties, instead they can only be described as “nominal”.

One attempted solution to the problem that metallic tubular membranes with internal diameters below 21 mm cannot be joined to metallic face plates, is the use of polymeric face plates. This is described in WO2012/00976. Polymeric products often used are resin-based, thermoplastic, thermosetting, polyurethane, epoxy or any combination of cross-linking. In these arrangements, the tubes are often glued (or potted) into the polymeric face plate. This attempted solution, however, has its own limitations. Given the different physical and chemical properties between metallic and polymeric products, tubular membrane modules constructed with metallic membranes and polymeric face plates have the following disadvantages; (1) the use of polymeric products makes them fragile, low tolerant to temperature, corrosive materials and pressure; (2) the metal and plastic components have different thermal properties and expand and contract at different rates when exposed to the same temperature, thereby weakening their bond and reducing the product life of the membrane module.

Another attempted solution is described in WO2012/009762. This patent application describes the use of metallic face plates with lower melting points than the membranes to ensure the membranes can be welded to reduce damage. However, one disadvantage with this attempted solution is that each membrane needs to be individually welded (attending to the time and cost) and the method still has limitations for membranes with diameters below 21 mm (and particularly at or below 8 mm) and the smaller the diameter, the higher the failure rate and the higher time consumption.

There exists a need in the art for a metallic tubular module which utilises a face plate which can accommodate metallic tubular membranes with internal diameters below 21 mm but which overcomes some or all of the problems associated with using polymeric face plates and welding membranes to metallic face plates. It is therefore an object of the present invention to overcome some or all of the deficiencies in the art.

### SUMMARY OF THE INVENTION

In its broadest aspect, the invention is a metallic face plate comprising a plurality of metallic tubular membranes adapted for a tubular membrane module, wherein the metallic tubular membranes and the metallic face plate are not joined by a weld and wherein the internal diameter of each tubular membrane is selected from the group consisting of; between 2 mm and 21 m; between 2 mm and 20 mm; between 2 mm and 19 mm; between 2 mm and 18 mm; between 2 mm and 17 mm; between 2 mm and 16 mm; between 2 mm and 15 mm; between 5 mm and 20 mm; and between 5 mm and 15 mm.

Preferably, the internal diameter of the metallic tubular membrane is selected from the group consisting of; 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm.

Preferably, the metallic tubular membranes are not joined to the metallic face plate by a weld. Preferably, the metallic tubular membranes are not joined to the face plate by welding, soldering or brazing. Preferably, the metallic tubular membranes are not joined to the face plate by a weld formed by melting the work pieces and adding a filler material to form a pool of molten material (the weld pool) that cools to become a joint. The term ‘weld’ as used herein refers to a joint between two units formed by melting the work pieces and adding a filler material to form a pool of molten material (the weld pool) that cools to become a joint. Preferably, the metallic tubular membranes are not joined to the metallic face plate by a metallic weld or a polymeric weld. Preferably, the metallic tubular membranes are not joined to the metallic face plate by a glue or bonding polymeric or ceramic material.

Preferably, the metallic tubular membranes are integrally joined to the face plate; that is, the face plate and the metallic tubular membranes are a complete unit. Preferably, the metallic tubular membranes are integrally joined to the face plate by the use of powder metallurgy techniques. Preferably, the metallic tubular membranes are integrally joined to the face plate by sintering. Preferably, the face plate has a melting temperature which is the same or substantially similar to the melting temperature of the metallic tubular membranes. Most preferably, the metallic membrane tubules and the metallic face plate form one solid piece. Most preferably, there is no join or seem between the metallic membrane tubules and the metallic face plate because they form one solid piece. For example, sintering is used to fuse the particles (by the atoms rapidly diffusing) in each unit together (the metallic face plate and the plurality of metallic tubular membranes) to form one solid piece.

Preferably, the metallic face plate is a support system for the metallic tubular membranes. Preferably, the metallic tubular membranes are porous.

Preferably, the metallic face plate comprises a plurality of apertures to receive a plurality of metallic tubular membranes. Preferably, the apertures have internal diameters of between 2 mm and 21 mm to house and seal with the metallic tubular membranes.

Preferably, the metallic face plate comprises between 2 and 1000 apertures to receive the metallic tubular membranes. Preferably, the metallic face plate comprises between 10 and 100 apertures. Preferably, the metallic face plate comprises between 10 and 75 apertures. Preferably, the metallic face plate comprises between 10 and 25 apertures.

Preferably, the metallic tubular membranes are selected from widely available membranes available in the art. More preferably, the metallic tubular membranes are selected from the membranes disclosed in WO 2008/064390 and WO 2008/064391. More preferably, the tubular membranes are multilayered. Preferably, the membrane includes a plurality of apertures extending there through, and at least some of said apertures increase in cross-sectional area from a first surface to the membrane to a second surface of the membrane.

Preferably, the metallic face plate is connected with and joined to the housing of the metallic tubular module.

In one aspect the housing of the tubular module is comprised of a polymeric composite such as polysulphone, polyvinyl or polyethylene. In another aspect the housing of the tubular module is metallic.

Preferably, the metallic face plate is a solid construction. Preferably, the metallic face plate is circular and joins and seals with the metallic tubular module housing. Preferably, the metallic membranes are cylindrical, the tubular module housing is cylindrical, and the metallic face plate is circular. Preferably the metallic tubular membranes are cylindrical.

Preferably, the face plate has a diameter selected from the group consisting of: between 10 mm to 2000 mm; between 10 mm to 1000 mm; between 20 mm to 800 mm; between 50 mm to 600 mm; 100 mm; 200 mm; 300 mm; 400 mm; and 500 mm. Preferably, the face plate has a thickness selected from the group consisting of: between 10 mm and 500 m; between 10 and 50 mm; between 20 and 30 mm; and 20 mm and 25 mm.

For example, the face plate has a diameter of 200 mm and using 6 mm diameter membranes it contains 480 membranes, and has a thickness of 20 mm or 25 mm.

Preferably, the metallic face plate is composed of a material selected from the group consisting of; solid stainless 316 stainless steel; duplex; super duplex; and titanium. Preferably, the metallic face plate and the membrane tubular membranes are composed of the same metal.

In a further aspect, the invention comprises a tubular membrane module comprising a plurality of metallic tubular membranes (a bundle of membranes) are described herein, at least one metallic face plate as described herein adapted to receive and support said membranes, and housing for the tubular membrane module as described herein and adapted to receive the permeate from the tubular membranes. Preferably, the tubular membrane module comprises two metallic face plates at either end of the tubular membrane model to support the membranes and seal the module. Preferably, the metallic face plate is circular and joins and seals with the metallic tubular module housing. Preferably, the metallic membranes are cylindrical, the tubular module housing is cylindrical, and the metallic face plate is circular.

In a further aspect, the invention is a method for producing a metallic face plate. Preferably, the metallic face plate is manufactured using powder metallurgy techniques.

Preferably, the metallic tubular membranes are not joined to the metallic face plate by a weld. Preferably, the metallic tubular membranes are not joined to the face plate by welding, soldering or brazing. Preferably, the metallic tubular membranes are not joined to the face plate by a weld formed by melting the work pieces and adding a filler material to form a pool of molten material (the weld pool) that cools to become a joint. The term ‘weld’ as used herein refers to a joint between two units formed by melting the work pieces and adding a filler material to form a pool of molten material (the weld pool) that cools to become a joint. Preferably, the metallic tubular membranes are not joined to the metallic face plate by a metallic weld or a polymeric weld. Preferably, the metallic tubular membranes are not joined to the metallic face plate by a glue or bonding polymeric or ceramic material.

Preferably, the metallic tubular membranes are integrally joined to the face plate; that is the face plate and the metallic tubular membranes are a complete unit. Preferably, the metallic tubular membranes are integrally joined to the face plate by the use of powder metallurgy techniques. Preferably, the metallic tubular membranes are integrally joined to the face plate by sintering. Preferably, the face plate has a melting temperature which is the same or substantially similar to the melting temperature of the metallic tubular membranes. Most preferably, the metallic membrane tubules and the metallic face plate form one solid piece. For example, sintering is used to fuse the particles in each unit together (by the atoms rapidly diffusing) to form one solid piece.

Preferably the metallic tubular membranes are manufactured using methods available in the art. Preferably, the metallic tubular membranes are produced by filling a mould which has a solid mandrel and elastomer outer with a metal powder particulate. Preferably, once filed the mould is then placed into an isostatic press and compressed under pressure up to 60,000 p.s.i. and the resultant green compact, is then sintered in a furnace having an insert atmosphere. More preferably, the membranes are manufactured using the methods described in WO2008/064390 and WO 2008/064391.

For example, the membranes are manufactured using the following method:
(a) Metal powders of various sieve sizes (depending on micron finish required) are mixed with various binders and are either heated or cooled depending on the binder selected;
(b) The mix is then extruded using specifically designed die heads (single or multi head dies) of various diameters from 3 mm to 20 mm or greater;
(c) As the membrane is extruded from the die head, the material is cured using a heating or cooling source, again depending on the binder selected (typically either hot air, induction heating or a cooling media);
(d) The membranes are cut to length and by the known art of sintering, are sintered;
(e) An inner coating is applied to the membranes either in a high vacuum furnace or a low hydrogen continuous furnace; and
(f) The membranes are re-sintered.

Preferably, the metallic face plate is produced by filling a mould, which attaches to the metallic tubular membranes, with a metal powder particulate. Preferably, once filed, the mould is then sintered in a furnace having an insert atmosphere. Preferably, once the mould is sintered further layers of particulate can be added to the tubular membranes.

Preferably, the metallic face plate is manufactured using a mixture containing, in part, a metallic particulate. For example, the metallic particulate comprises a base material such as N-metal, priodyne, ethylene, glycol or similar and further including a metal base power, such as but not limited to, stainless steel, tungsten, silica, boron, cobalt, chromium, nickel and/or silver nitride. More preferably, the mixture is blended into a homogenous consistency at a constant temperature. Preferably, the mixture is heated to a temperature ranging from 38° C. to 110° C. and constantly stirred for a period of between 2 and 24 hours. Preferably, the de binding of the binding agents is then performed using controlled heat and ramp rates in an oxygen atmosphere. Preferably, following the complete removal of the binding agents, the tubular membranes and the face plate are sealed in a vessel and a vacuum is applied. Preferably, heat via the elements is then applied to raise the temperature to approximately 1100° C. Preferably, the induction heater is initiated and quickly increases the powered metal to a temperature of approximately of 1350° C. to sinter the cast. Preferably, the tubular membranes and the face plate are heated for between 1 and 20 minutes. Preferably, the time frame enables full density of the face plate metal but does not affect the porosity of the tubular membranes. Preferably, after the heat source is removed, cooling is initiated via the cooling jacket and at the same time the vacuum is replaced with a positive pressure of argon gas. Preferably, the coating of the lumens with the inner particulate coat can be performed simultaneously to complete the tubular membranes.

In one preferred embodiment, the method of producing the metallic face plate includes the steps of:
(1) Following the extrusion and sintering of the lumen tubes, they are fitted into a support system to prevent sagging and or damage;
(2) The support system comprises a base made up from a stainless shell complete with a cooling jacket. Fitted to the inside of the base is a mould comprised of graphite. Inserted into the graphite is a series of high temperature heating elements and thermo couples to measure and control the temperature.
(3) Fitted to the outer most part of the graphite mould is an electrical connection fed from an induction heater. Fine metallic powders are then mixed with binding agents to liquefy the mix. This is then pumped into the mould using prepared grooves until the mould is filled to the desired level. Preferably, the metallic face plate is manufactured using a mixture containing, in part, a metallic particulate. For example, the metallic particulate comprises a base material such as N-metal, priodyne, ethylene, glycol or similar and further includes a metal base power, such as but not limited to, stainless steel, tungsten, silica, boron, cobalt, chromium, nickel and/or silver nitride. More preferably, the mixture is blended into a homogenous consistency at a constant temperature. Preferably, the mixture is heated to a temperature ranging from 38° C. to 110° C. and constantly stirred for a period of between 2 and 24 hours.
(4) De binding of the binding agents is then performed using controlled heat and ramp rates in an oxygen atmosphere.
(5) Following the complete removal of the binding agents, the tubular membranes and the face plate are sealed in a vessel and a vacuum is applied. Heat via the elements is then applied to raise the temperature to 1100° C. At this point the induction heater is initiated and quickly increases the powered metal to a temperature of 1350° C. to sinter the cast. The time frame for this is only a matter of minutes to enable full density of the face plate metal but does not affect the porosity of the tubular membranes.
(6) With the heat source removed, cooling is initiated via the cooling jacket and at the same time the vacuum is replaced with a positive pressure of argon gas.
(7) The coating of the lumens with the inner particulate coat can now be performed simultaneously to complete the tubular membranes.

In a further aspect, the invention is a method for producing a metallic tubular membrane module comprising the steps of producing a plurality of metallic tubular membranes, housing for the module and at least one metallic face plate. Preferably, the metallic tubular membrane module is manufactured using powder metallurgy techniques.

The invention described herein has one or more of advantages over the prior art including any one or all of the following advantages; the support system is robust and can withstand high pressures compared to polymeric support systems; the use of powder injection molding and extrusion techniques has opened up the opportunity of lowering manufacturing costs; the removal of the need to weld the membranes into the face plate (by using powder metallurgy techniques) has reduced time and cost; the removal of the need to weld the membranes into the face plate (by using powder metallurgy techniques) has reduced potential damage that welding (and its associated heat) may cause to membranes with diameters below 21 mm and allowed for robust metallic support systems to be used with smaller membranes (below 21 mm) and membrane bundles.

The invention described herein has application for the filtration of fluids. The invention can have application in one or more of the following industries; mining, oil and gas, refining, light and heavy manufacturing, food and wine processing and manufacturing, water purification and management and agricultural industries.

Other aspects and advantages of the invention will become apparent to those skilled in the art from a review of the ensuing description.

### BRIEF DESCRIPTION OF THE DRAWINGS

FIG. 1: Illustrates a cross-sectional view of a device to produce a metallic face plate joined to a plurality of metallic membranes.

FIG. 2: Illustrates a cross-sectional view of the device of FIG. 1 contained within a induction vacuum chamber.

### DETAILED DESCRIPTION OF THE INVENTION

General

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in the specification, individually or collectively and any and all combinations or any two or more of the steps or features.

The present invention is not to be limited in scope by the specific embodiments described herein, which are intended for the purpose of exemplification only. Functionally equivalent products, compositions and methods are clearly within the scope of the invention as described herein.

The invention described herein may include one or more ranges of values (e.g. size, concentration etc). A range of values will be understood to include all values within the range, including the values defining the range, and values adjacent to the range that lead to the same or substantially the same outcome as the values immediately adjacent to that value which defines the boundary to the range.

The entire disclosures of all publications (including patents, patent applications, journal articles, laboratory manuals, books, or other documents) cited herein are hereby incorporated by reference. Inclusion does not constitute an admission is made that any of the references constitute prior art or are part of the common general knowledge of those working in the field to which this invention relates.

The disclosures of all publications (including patents, patent applications, journal articles, laboratory manuals, books, or other documents) cited herein does not constitute an admission that any of the references constitute prior art or are part of the common general knowledge of those working in the field to which this invention relates.

Throughout this specification, unless the context requires otherwise, the word “comprise” or variations, such as “comprises” or “comprising” will be understood to imply the inclusion of a stated integer, or group of integers, but not the exclusion of any other integers or group of integers. It is also noted that in this disclosure, and particularly in the claims and/or paragraphs, terms such as “comprises”, “comprised”, “comprising” and the like can have the meaning attributed to it in US Patent law; e.g., they can mean “includes”, “included”, “including”, and the like.

The present invention will now be described with reference to the following non-limiting Examples. The description of the Examples is in no way limiting on the preceding paragraphs of this specification, but is provided for exemplification of the methods and compositions of the invention.

### EXAMPLES

It will be apparent to persons skilled in the materials and metalurgical arts that numerous enhancements and modifications can be made to the above described processes without departing from the basic inventive concepts. All such modifications and enhancements are considered to be within the scope of the present invention, the nature of which is to be determined from the foregoing description and the appended claims. Furthermore, the following Examples are provided for illustrative purposes only, and are not intended to limit the scope of the processes or compositions of the invention.

### Example 1

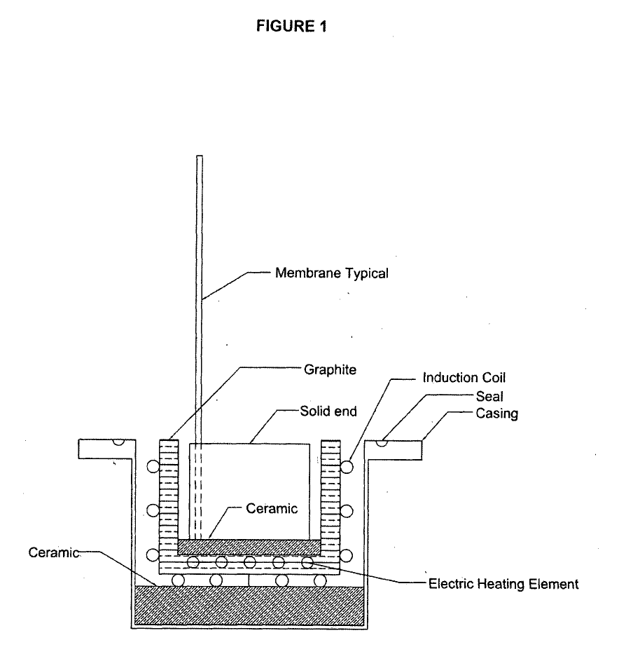

This example is described with reference to FIG. 1.

Following the extrusion and sintering of the lumen tubes (membrane typical), they are fitted into a support system (solid end) to prevent sagging and or damage.

The support system comprises a base (casing) up from ceramic stainless shell complete with a cooling jacket (not shown) and a ceramic bass (ceramic). Fitted to the inside of the base is a mould (graphite) comprised of graphite. Inserted into the mould is a series of high temperature heating elements (electric heating element) and thermo couples to measure and control the temperature. The mould (graphite) also comprises a ceramic base (ceramic).

Fitted to the outer most part of the graphite mould is an electrical connection (Induction coil) fed from an induction heater. Fine metallic powders are then mixed with binding agents to liquefy the mix. This is then pumped into the mould using prepared grooves until the mould is filled to the desired level. Preferably, the metallic face plate is manufactured using a mixture containing, in part, a metallic particulate. For example, the metallic particulate comprises a base material such as N-metal, priodyne, ethylene, glycol or similar and further includes a metal base power, such as but not limited to, stainless steel, tungsten, silica, boron, cobalt, chromium, nickel and/or silver nitride. More preferably, the mixture is blended into a homogenous consistency at a constant temperature. Preferably, the mixture is heated to a temperature ranging from 38° C. to 110° C. and constantly stirred for a period of between 2 and 24 hours.

De binding of the binding agents is then performed using controlled heat and ramp rates in an oxygen atmosphere.

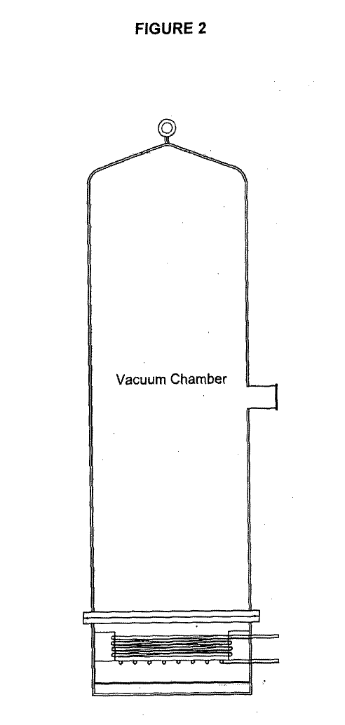

Following the complete removal of the binding agents, the tubular membranes and the face plate are sealed in a vessel (in the vaccum chamber) and a vacuum is applied (FIG. 2). Heat via the elements is then applied to raise the temperature to 1100° C. At this point the induction heater is initiated and quickly increases the powered metal to a temperature of 1350° C. to sinter the cast. The time frame for this is only a matter of minutes to enable full density of the face plate metal but does not affect the porosity of the tubular membranes.

With the heat source removed, cooling is initiated via the cooling jacket and at the same time the vacuum is replaced with a positive pressure of argon gas.

The coating of the lumens with the inner particulate coat can now be performed simultaneously to complete the tubular membranes.

1. A metallic face plate comprising a plurality of metallic tubular membranes adapted for a tubular membrane module, wherein the metallic tubular membranes and the metallic face plate are not joined by a weld and wherein the internal diameter of each tubular membrane is selected from the group consisting of; between 2 mm and 21 mm.

2. The metallic face plate of claim 1, comprising a plurality of apertures to receive the plurality of metallic tubular membranes.

3. The metallic face plate of any one of claim 1 or 2, wherein the apertures have internal diameters of between 2 mm and 21 mm to house the metallic tubular membranes.

4. The metallic face plate of any one of claim 2 or 3, comprising between 10 and 100 apertures.

5. The metallic face plate of any one of the preceding claims, wherein the face plate is circular.

6. The metallic face plate of any one of the preceding claims, comprised of 316 stainless steel.

7. The metallic tubular membrane module comprising at least one metallic face plate comprising a plurality of metallic tubular membranes according to claims 1 to 6, adapted to receive and support said membranes, and housing for the tubular membrane module adapted to receive the permeate from the tubular membranes.

8. The metallic tubular membrane module according to claim 7, comprising two metallic face plates positioned at either end of the tubular membrane model to support the membranes and seal the module.

9. The metallic tubular membrane module according to claim 7, wherein the metallic membranes are cylindrical, the tubular module housing is cylindrical, and the metallic face plate is circular.

10. The metallic tubular membrane module according to claims 7 to 10, wherein the metallic tubular membranes comprise a plurality of apertures extending therethrough wherein at least some of the said apertures increase in cross-sectional area from a first surface of the membrane to a second surface of the membrane.

11. A method for producing a metallic face plate as claimed by claims 1 to 7.

12. A method for producing a metallic tubular membrane module as claimed by claims 8 to 10.

13. The method of any one of claim 11 or 12, using powder metallurgy techniques.

14. A metallic face plate substantially as herein described with reference to examples.

15. A metallic tubular membrane module substantially as herein described with reference to examples.

16. A method for producing a metallic face plate substantially as herein described with reference to examples.

17. A method for producing a metallic tubular membrane module substantially as herein described with reference to examples.
